(19) United States
(12) Patent Application Publication
(10) Pub. No.: US 2026/0068900 A1
(43) Pub. Date: Mar. 12, 2026

(54) METHOD FOR PRODUCING VEGETABLE HARD CHEESE WITH IMPROVED PROPERTY AND FLAVOR AND VEGETABLE HARD CHEESE PRODUCED THEREBY

(71) Applicant: ARMORED FRESH. INC, Seoul (KR)

(72) Inventors: Geun Seo YANG, Seoul (KR); Young Min HA, Seoul (KR); Sooh Hwan KIM, Seoul (KR)

(21) Appl. No.: 18/931,891

(22) Filed: Oct. 30, 2024

(30) Foreign Application Priority Data
Sep. 10, 2024 (KR) 10-2024-0123202

(51) Int. Cl. A23C 20/02

(52) U.S. Cl. CPC A23C 20/025; A23C 2240/15; A23C 2250/05

(57) ABSTRACT

The method for producing vegetable hard cheese with improved property and flavor comprises a ingredient input step S100 of preparing and placing ingredients in a container, an emulsifying step S200 of mixing and stirring the ingredients in the container to produce an emulsion, a sterilization step S300 of heating the emulsion for sterilization, a shaped packaging step S400 of packaging the sterilized emulsion in a slice form or block form, a cooling step S500 of cooling and solidifying the emulsion packaged in the slice form or block form to produce a solidified vegetable cheese, and a grinding processing step S600 of grinding the solidified vegetable cheese to produce a vegetable hard cheese.

### CROSS-REFERENCE TO RELATED APPLICATION

This application claims priority to Korean Patent Application No. 10-2024-0123202 filed in the Korean Intellectual Property Office on Sep. 10, 2024, the disclosure of which is incorporated by reference herein in its entirety.

### TECHNICAL FIELD

The present disclosure relates to a method for producing a vegetable hard cheese with improved properties and flavor and a vegetable hard cheese produced thereby, and more particularly to a method for producing a vegetable hard cheese with improved properties and flavor and a vegetable hard cheese produced thereby, which can significantly reduce the solidification time compared to conventional vegetable cheeses by comprising a starch with a high amylose content and reducing the moisture content.

### DISCUSSION OF RELATED ART

In general, cheese is a fermented, ripened food made from dairy products such as whole milk, skim milk, cream, and buttermilk by adding lactic acid bacteria, rennet or other proteolytic enzymes, acids, etc. to coagulate casein, remove whey, and then heat, press, etc.

Cheese is useful as a source of nutrition because it contains abundant nutrients such as protein, fat, minerals, vitamins, and lactic acid bacteria in a form that is easy to digest and absorb, and is loved by many people for its savory and rich flavor, which is applied to various dishes such as pizza and cheese pork cutlets.

Casein, a component of cheese, is a protein found in the milk of mammals such as cows, goats, buffalo, and sheep, and is widely used as an ingredient in cheese, but cheese containing casein or lentils for enzymatic processing of casein has been inaccessible to vegans, vegetarians, and certain people who are restricted from eating animal products for religious or health reasons.

As a result, there is a strong demand for vegan cheeses that exclude the use of animal ingredients in cheese. Meanwhile, a major issue in manufacturing vegan cheese is to ensure that the cheese does not harden and retains its stretchability for a long time after melting compared to conventional vegan cheese.

Among the prior art, U.S. Public Patent No. 2021-0120834 (Composition of vegan cheese and method of preparing the same) discloses a vegan cheese composition comprising vegetable oil and starch instead of dairy products, but the conventional vegan cheese composition cannot maintain good stretchability of the cheese after a certain period of time after melting instead of immediately after melting, and cannot prevent oil separation during the melting process of the cheese.

Therefore, there is an urgent need to develop a vegan cheese that can maintain the stretchability of the cheese even after melting and reduce or prevent oil separation, thereby maintaining the chewy, long-stretching texture and savory flavor characteristic of the cheese for a long period of time.

### SUMMARY

The present disclosure is to provide a method for producing a vegetable hard cheese with improved properties and flavor and a vegetable hard cheese produced thereby, which can significantly reduce the solidification time compared to conventional vegetable cheeses by comprising a starch with a high amylose content and reducing the moisture content.

Further, the present disclosure is to provide a method for producing a vegetable hard cheese with improved properties and flavor and a vegetable hard cheese produced thereby, which can be rapidly solidified in less than one week and crushed to produce a hard cheese, resulting in a significant increase in productivity due to a reduction in manufacturing time, melting properties at a temperature similar to that of natural hard cheeses, and improved preservation and excellent texture.

Various problems to be solved by the present disclosure are not limited to the problems mentioned above, and other problems not mentioned are clearly understood by those skilled in the art from the description below.

One embodiment of the present disclosure discloses a method for producing vegetable hard cheese with improved property and flavor.

The method for producing vegetable hard cheese with improved property and flavor comprises a ingredient input step S100 of preparing and placing ingredients in a container, an emulsifying step S200 of mixing and stirring the ingredients in the container to produce an emulsion, a sterilization step S300 of heating the emulsion for sterilization, a shaped packaging step S400 of packaging the sterilized emulsion in a slice form or block form, a cooling step S500 of cooling and solidifying the emulsion packaged in the slice form or block form to produce a solidified vegetable cheese, and a grinding processing step S600 of grinding the solidified vegetable cheese to produce a vegetable hard cheese.

In the ingredient input step S100, the ingredients may comprise purified water, vegetable oil, starch, modified starch, salt and flavoring.

The vegetable oil may include at least one selected from the group consisting of coconut oil, sunflower oil, rapeseed oil, canola oil, cottonseed oil, peanut oil, olive oil, moringa oil, algae oil, safflower oil, corn oil, rice bran oil, sesame oil, hazelnut oil, avocado oil, almond oil, walnut oil, cashew nut oil, shea butter, palm oil, and cocoa butter.

The starch may include at least one selected from the group consisting of potato starch, corn starch, and tapioca starch.

The modified starch may include at least one selected from the group consisting of oxidized starch, starch sodium octenyl succinate, and hydroxypropyl distarch phosphate.

In the ingredient input step S100, the ingredients may include 10 to 20 parts by weight of purified water, 40 to 50 parts by weight of vegetable oil, 5 to 15 parts by weight of starch, 5 to 15 parts by weight of modified starch, 2 to 6 parts by weight of salt, and 1 to 3 parts by weight of flavoring.

The emulsifying step S200 may comprise mixing the ingredients in the container and stirring the mixed ingredients at a speed of 500 to 600 rpm for 1 to 5 minutes to produce a homogenized emulsion.

The sterilization step S300 may comprise sterilizing the emulsion at a temperature of 86 to 94° C. for 30 to 90 seconds.

The cooling step S500 may comprise cooling the emulsion packaged in slice form or block form at a temperature of 0 to 4° C. for 6 to 8 days for solidification.

Further, anther embodiment of the present disclosure disclose a vegetable hard cheese with improved properties and flavor prepared by the above methods.

Details of other embodiments are included in the detailed description.

The method of producing a vegetable hard cheese with improved properties and flavor according to various embodiments of the technical idea of the present disclosure can significantly reduce the solidification time compared to conventional vegetable cheeses by using starch with a high amylose content and reducing the moisture content.

The method of producing a vegetable hard cheese with improved properties and flavor according to various embodiments of the technical idea of the present disclosure can rapidly solidify in less than one week and crush to produce a hard cheese, resulting in a significant increase in productivity due to a reduction in manufacturing time, melting properties at a temperature similar to that of natural hard cheeses, and improved preservation and excellent texture.

It is fully understood that various embodiments of the technical idea of the present disclosure may provide various effects not specifically mentioned.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flowchart illustrating a method of producing a vegetable hard cheese with improved properties and flavor according to an embodiment of the technical idea of the present disclosure.

### DETAILED DESCRIPTION OF EXEMPLARY EMBODIMENTS

Advantages and characteristics of the present disclosure, and methods for achieving them become clear with reference to the embodiments described later in detail. However, the present disclosure is not limited to the embodiments described herein and may be embodied in other forms. Rather, the embodiments introduced herein are provided so that the disclosed content is thorough and complete and the spirit of the present disclosure is sufficiently conveyed to those skilled in the art.

Terms used in this application are only used to describe specific embodiments and are not intended to limit the present disclosure. Singular expressions include plural expressions unless the context clearly dictates otherwise.

Unless defined otherwise, all terms used herein, including technical or scientific terms, have the same meaning as commonly understood by one of ordinary skill in the art to which the present disclosure belongs. Terms such as those defined in commonly used dictionaries should be interpreted as having a meaning consistent with the meaning in the context of the related art, and unless explicitly defined in this application, it is not to be construed in an ideal or overly formal sense.

Hereinafter, with reference to the attached drawings, a method of producing a vegetable hard cheese with improved properties and flavor according to an embodiment of the technical idea of the present disclosure will be described in detail with preferred embodiments.

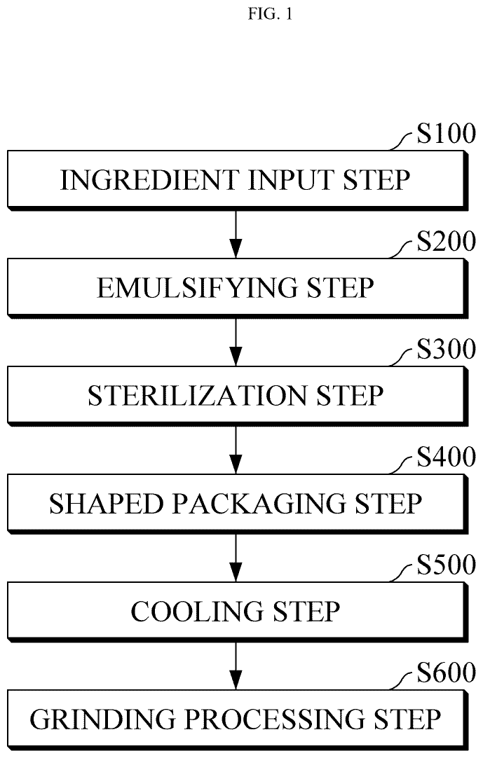

FIG. 1 is a flowchart illustrating a method of producing a vegetable hard cheese with improved properties and flavor according to an embodiment of the technical idea of the present disclosure.

Referring to FIG. 1, a method of producing a vegetable hard cheese with improved properties and flavor according to an embodiment of the technical idea of the present disclosure includes an ingredient input step S100, an emulsifying step S200, a sterilization step S300, a shaped packaging step S400, a cooling step S500, and a grinding processing step S600.

### 1. S100: Ingredient Input Step

The ingredient input step S100 is a step in which the ingredients for manufacturing the vegetable hard cheese are prepared and input into the container.

In the ingredient input step S100, the ingredients may include purified water, vegetable oil, starch, modified starch, salt, and flavoring and for example, include 10 to 20 parts by weight of purified water, 40 to 50 parts by weight of vegetable oil, 5 to 15 parts by weight of starch, 5 to 15 parts by weight of modified starch, 2 to 6 parts by weight of salt, and 1 to 3 parts by weight of flavoring.

Vegetable oils are oils obtained from plants, and those that are liquid at room temperature are called oils, and those that are solid at room temperature are called fat, and they may comprise, for example, one or more selected from the group consisting of coconut oil, sunflower oil, rapeseed oil, canola oil, cottonseed oil, peanut oil, olive oil, moringa oil, algae oil, safflower oil, corn oil, rice bran oil, sesame oil, hazelnut oil, avocado oil, almond oil, walnut oil, cashew nut oil, shea butter, palm oil, and cocoa butter.

Starch is a polymeric carbohydrate composed of multiple glucose units linked by glycoside bonds and is synthesized by plants such as wheat, rice, corn, potatoes, and arrowroot. The starch comprises amylose, which is produced from α-1, 4-glycoside bonds of glucose, and amylopectin, which is composed of α-1, 6-glycoside bonds, and for example, the starch may be one or more selected from the group consisting of potato starch, corn starch, and tapioca starch.

The potato starch is a starch obtained from the stem of the potato Solanum tuberosum L. (Solanaceae) and can be obtained by crushing, sieving, separating and purifying, dehydrating and drying the potato. The potato starch is used for food and medicinal purposes in addition to its use as a starch due to its low protein content and high whiteness, and potato starch has a lower gelatinization temperature and a translucent paste state than other starches when heated with water.

The corn starch is produced from the seeds of corn Zea mays L. (Gramineae), which is the whitest and finest grained starch among other starches, and has a high gelatinization temperature and excellent high temperature stability.

The tapioca starch is a starch obtained from the roots of cassava in the tropics, and is obtained by refining the starch milk obtained by washing, peeling, crushing, and sieving the roots of cassava and drying it with cold air or warm air. The tapioca starch has a small proportion of amylose content, is easy to be gelatinized, and has the properties of being difficult to age.

Modified starch is a food additive that is added to increase the stickiness and viscosity of food products and to promote emulsion stability, and can be prepared by treating starch with a small amount of chemicals to chemically modify or gelatinize it by a reaction between hydroxy groups of starch and reactive substances, such as functional groups such as acetic acid groups or phosphate groups, and for example, the modified starch may include one or more selected from the group consisting of oxidized starch, starch sodium octenyl succinate, and hydroxypropyl distarch phosphate.

The oxidized starch may be a modified starch in which the starch has been treated with various oxidizing agents, and can be obtained as a powder by mixing the starch with water and vigorously oxidizing the starch with a chlorine-based oxidizing agent such as hypochlorous acid at or below gelatinization temperature, followed by washing, removal of the oxidizing agent, and drying.

The starch sodium octenyl succinate may be prepared by esterification of starch with 1-octenyl succinic anhydride, wherein 1-octenyl succinic anhydride is succinic anhydride with an octenyl group, which is a hydrocarbon.

The hydroxypropyl distarch phosphate may be prepared by esterification reaction with phosphorus oxide or meta trisodium phosphate and etherification reaction with propylene oxide, and is a component commonly used as a food additive to improve the gloss or color of food.

The salt may be included to enhance the taste and improve the preservation of the hard cheese, and the flavoring may be included to produce a hard cheese of a desired flavor.

In another embodiment of the technical idea of the present disclosure, the method of preparing a vegetable hard cheese with improved properties and flavor may further comprise, in addition to the ingredients comprising purified water, vegetable oil, starch, modified starch, salt and flavoring, a thickener, which may be further included in a weight ratio of from 1 to 5 parts by weight.

The thickener may impart viscosity to the hard cheese, imparts stability during cold thawing, improve texture, and inhibit the phenomenon of syneresis to improve preservation, and it may preferably comprise a sodium alginate extract and xanthan gum, for example, the thickener may further comprise a mixture of sodium alginate extract and xanthan gum, for example, a mixture of sodium alginate extract and xanthan gum in a weight ratio of 1:1.

The sodium alginate extraction mixture may be prepared using Sargassum horneri, which is biologically classified as Plantae kingdom, Phaeophyceae class, Fucales order, and Sargassaceae family and is mainly distributed on the west coast of the North Pacific Ocean, where it grows in the lower intertidal zone. It is easily observed that part of its body floats on the surface of the water during low tide in the domestic coastal waters, and it is the most common species of marine forest, but young individuals are edible, and in spring, it falls off the rocks and floats on the coast in the form of a floating horse.

Sargassum horneri is yellowish brown, and the stem that grows from the button-shaped root is long as a single strand or sometimes splits into two and branches out from the upper part. Currently, its effects have been reported for atopic suppression, anti-inflammatory effects, and heavy metal adsorption, and screening experiments have reported antioxidant, inhibitory effects on adipocyte production, inhibitory effects on cancer cell proliferation, and anticoagulant effects.

The sodium alginate extraction mixture can be prepared by the following methods.

To prepare the sodium alginate extraction mixture, first, Sargassum horneri may be washed and dried.

By washing Sargassum horneri, debris, salts, contaminants, and the like attached to Sargassum horneri can be removed. For example, the washing and drying of Sargassum horneri may be performed by washing Sargassum horneri with purified water, followed by dehydrating said washed Sargassum horneri and storing it at a temperature of 20 to 30° C. for 20 to 40 hours to dry.

Next, the dried Sargassum horneri may be crushed and cut.

Sargassum horneri is cut using a known crusher so that the useful components contained in Sargassum horneri can be easily extracted in a subsequent process. For example, Sargassum horneri can be cut into 1 to 3 cm long units.

Next, Sargassum horneri can be subjected to hot water extraction to prepare a Sargassum horneri hot water extract.

The Sargassum horneri hot water extract can be prepared by mixing 800 to 1,200 parts by weight of water with 100 parts by weight of Sargassum horneri, heating at a temperature of 93 to 97° C. for 60 to 120 minutes, performing hot water extraction, and then filtering the filtrate.

Next, the solid matter of the remaining Sargassum horneri after the hot water extraction can be extracted to produce sodium alginate.

In general, the sodium alginate is a white-light yellow fiber, grain, granule or powder with the chemical formula (C₆H₇O₆Na)ₙ, it is a bio-derived substance with almost no odor and no taste, and it is used as a stabilizer for ice cream, an adhesive for ketchup, mayonnaise, sauce, etc., a fining agent for sake, a gelling agent, an emulsifier, a thickener, etc. to increase the adhesiveness and viscosity of food, promote emulsion stability, and improve the physical properties and texture of food.

The sodium alginate is a high molecular weight substance and exists in various grades through a purification process. When dissolved in water, it becomes viscous and the pH of a 1% aqueous solution is 6 to 8, which means it has almost neutral properties. Sodium alginate has the property of hardening when it comes into contact with sodium chloride (NaCl) or in low pH conditions. Due to these properties, sodium alginate has been used as a thickener, etc.

As a method for extracting the solid substance of Sargassum horneri, any one of the following methods can be selected and used: hot water extraction, cold immersion extraction, reflux cooling extraction, solvent extraction, steam distillation, ultrasonic extraction, dissolution, and pressing. Further, the desired extract may be subjected to additional conventional fractionation processes, and it may be purified using conventional purification methods.

For example, the extraction of the sodium alginate may be performed according to the method of Calumpong et al (1999), and specifically, the sodium alginate may be produced by a method in which 800 mL of 2% formaldehyde is added to 25 g of Sargassum horneri, the mixture is first pretreated at room temperature for 24 hours, then the Sargassum horneri is washed, the mixture is second pretreated in 800 mL of 0.2 M hydrochloric acid (HCl) for 24 hours, then Sargassum horneri that has undergone the pretreatment process is immersed in 1 L of 2% sodium carbonate (Na₂CO₃), extracted at 60 to 80° C. for 1 to 3 hours, the extracted solution is centrifuged at 3,200 rpm for 25 minutes, and then precipitated in 3 times the volume of 95% ethanol, and then finally dried at 60° C. for 50 hours.

Next, the Sargassum horneri hot water extract and the sodium alginate may be mixed to prepare a sodium alginate extract mixture.

For example, the sodium alginate extract mixture may be prepared by mixing and then stirring 80 to 120 parts by weight of the Sargassum horneri hot water extract with respect to 100 parts by weight of the total amount of the sodium alginate.

Further, in the method for producing vegetable hard cheese with improved properties and flavor according to another embodiment of the technical idea of the present disclosure, sea salt powder may be used instead of the salt mentioned above. Generally, sea salt is rich in minerals, and Korean sea salt is based on a tidal flat salt farm rich in minerals, one of the world's five largest tidal flats.

With this production base, sea salt is an alkaline salt that is good for the body, has low oxidation, and contains various cations such as calcium (Ca), magnesium (Mg), and potassium (K), so it has an excellent anti-softening effect, and has maintained the unique taste and flavor of Korean traditional foods such as kimchi, soy sauce, and salted seafood.

This salt contains not only sodium chloride but also brine (MgCl₂·6H₂O) and impurities. This brine is the remaining solution after salt is extracted by concentrating seawater or salt water. Its main ingredient is magnesium chloride, and it has a unique, irritating, bitter taste, which reduces the taste of food when used in cooking.

The sea salt powder may be a sea salt powder with the bitterness of brine removed and the taste and flavor enhanced, and the sea salt powder may be a sea salt powder manufactured by the following method.

In order to manufacture the sea salt powder, first, sea salt may be dissolved in purified water to manufacture a sea salt solution.

The sea salt is manufactured by trapping seawater and evaporating it with sunlight and wind, and crystallizing it, and this sea salt may contain fine impurities. Accordingly, the sea salt is dissolved in purified water to prepare a sea salt solution, and fine impurities contained in the purified water can be dissolved or separated from the dissolved sea salt.

Next, the sea salt solution may be evaporated or dried to recrystallize the sea salt.

The recrystallization of the sea salt may be performed by evaporating or drying the sea salt solution in a chamber preheated to 450 to 550° C. for 100 to 300 minutes. For example, the evaporation or drying of the sea salt solution may be performed by supplying the sea salt solution from which fine impurities have been removed in the form of spraying the solution into the chamber through a supply nozzle, thereby recrystallizing the sea salt.

The configuration of the device for evaporating or drying the sea salt is a known technology, so detailed description thereof is excluded for convenience of explanation and clarity of the technical idea of the present disclosure.

Next, the recrystallized sea salt may be heated.

The recrystallized sea salt may be heated to thermally decompose and vaporize components or solids contained in the above recrystallized sea salt and remove them. For example, the recrystallized sea salt may be heated at a temperature of 1100 to 1300° C. for 20 to 60 minutes. Then, the heated recrystallized sea salt may be cooled and then pulverized to make powder.

Next, the heated recrystallized sea salt may be cooled and then crushed into powder.

The powdering of the heated recrystallized sea salt may be performed by grinding using a known grinder, etc., and the configuration of cooling the heated recrystallized sea salt and then grinding it using a grinder is a known technology, so a detailed description thereof will be excluded for convenience of explanation and clarity of the technical idea of the present disclosure.

Next, the recrystallized sea salt powder may be mixed with green tea and pine needle shoots to produce a sea salt mixture.

The sea salt mixture is prepared by mixing green tea leaves and pine needle shoots with the recrystallized sea salt powder, thereby enhancing the taste and flavor of the sea salt and adding the nutrients of the green tea leaves and pine needle shoots. and for example, the sea salt mixture may be prepared by mixing 1 to 5 parts by weight of green tea leaves and 3 to 7 parts by weight of pine needle shoots with respect to 100 parts by weight of the total content of the recrystallized sea salt powder.

The green tea is one of the most widely consumed beverages around the world. The main components of green tea include catechin, caffeine, amino acids, vitamins, and minerals, and these components are reported to exhibit various physiological activities. In particular, catechin, one of the active ingredients of green tea, is known to have anti-tumor, anti-cancer, antioxidant, apoptosis-inducing, anti-angiogenic, and cholesterol-lowering effects.

The pine needle shoots are the leaves and shoots of pine trees (Pinus densiflora Siebold et Zuccarini), and include the leaves and shoots of trees that have a long history with Korean in Northeast Asia, including Korea, China, and Japan. Fresh pine needles contain large amounts of ascorbic acid, vitamins A, B, and K, bitter substances, flavonoids, anthocyanins, 7 to 12% resin, about 5% tannin, carbohydrates, and essential oils.

In addition, the entire pine tree contains components that promote metabolism and expel waste products from the body, such as alcohol and ester, phenol compounds, quinine, turpentine, vitamins A, C, and chlorophyll as main components, as well as glycogenin and abietic acid. It is also rich in iron, and 24 types of amino acids are contained in red pine leaves, and 19 types of amino acids that make up proteins have also been confirmed.

The pine needles are the source and raw material of vitamin C, and because they are much darker green, abundant carotene is consumed. The pharmacological value of pine needles can be explained by the general effects of terpenes, phenolic compounds, and tannins. In addition, it is good for high blood pressure, stroke, diabetes, dementia, anti-aging, anti-cancer effects, liver and stomach, constipation, anemia, chronic alcoholism, hangover relief, nicotine removal, skin beauty, constitution improvement diet, men's stamina, a case in which the head is heavy and the eyes are dim due to various stresses. excessive smoking. and drinking, and especially for students or examinees who are studying.

Next, the sea salt mixture may be aged to produce an aged sea salt mixture.

The sea salt mixture is stored for a certain period of time and matured, so that any remaining brine in the sea salt mixture is completely removed, and a mature sea salt mixture in which the fragrance and nutrients of green tea and pine needle shoots are sufficiently absorbed may be manufactured. For example, the mature sea salt mixture can be manufactured by storing and maturing the sea salt mixture at a temperature of 13 to 17° C. for 20 to 30 months.

Next, the aged sea salt mixture may be filtered to produce sea salt powder.

The above sea salt powder can be manufactured by filtering the above aged sea salt mixture using a known filter to separate and remove solids such as green tea and pine needle shoots. The configuration of filtering solids using a filter is a known technology, so a detailed description thereof will be excluded for convenience of explanation and clarity of the technical idea of the present disclosure.

### 2. S200: Emulsifying Step

The emulsifying step S200 is a step of mixing and stirring the ingredients put into the container to prepare an emulsion.

The emulsifying step S200 may be performed by mixing the ingredients put into the container and stirring them to prepare a homogenized emulsion. For example, the emulsifying step S200 may be performed by mixing the ingredients put into the container and stirring them at a speed of 500 to 600 rpm for 1 to 5 minutes to prepare a homogenized emulsion.

### 3. S300: Sterilization Step

The sterilization step S300 is a step of sterilizing by heating the emulsion.

The sterilization step S300 is performed by heating and sterilizing the emulsion, thereby increasing the storage properties of the cheese and extending the distribution period. For example, the sterilization step S300 can be performed by sterilizing the emulsion at a temperature of 86 to 94° C. for 30 to 90 seconds.

### 4. S400: Shaped Packaging Step

The shaped packaging step S400 is a step for packaging the sterilized emulsion in a slice or block form.

In the shaped packaging step S400, the sterilized emulsion is configured in a liquid form before being cooled and solidified, In the shaped packaging step S400, the sterilized emulsion can be packaged in a slice or block form.

### 5. S500: Cooling Step

The cooling step S500 is a step of cooling and solidifying the emulsion packaged in the slice form or block form to produce a solidified vegetable cheese.

For example, the cooling step S500 is performed so that the emulsion packaged in the form of the slice or block can be solidified by cooling it at a temperature of 0 to 4° C. for 6 to 8 days to manufacture vegetable cheese. The present disclosure comprises starch with a high amylose content and lowers the moisture content (for example, the moisture content of the conventional one is 55±3%, but the moisture content of the present disclosure is lowered to 40±3%), so that the solidification time can be significantly shortened compared to conventional vegetable cheese, and the manufacturing time can be shortened, so that a significant increase in productivity can be expected.

### 6. S600: Grinding Processing Step

The grinding processing step S600 is a step of grinding the solidified vegetable cheese to produce hard cheese.

For example, in the grinding processing step S600, the solidified vegetable cheese can be grinded and finely shredded or grated to manufacture hard cheese. The present disclosure manufactures hard cheese by finely shredding or grating, thereby manufacturing vegetable hard cheese having a melting point and excellent flavor and texture similar to that of hard cheese (Parmigiano Reggiano, Pecorino Romano, etc.) among natural cheeses.

Further, the hard cheese manufactured through the grinding processing step S600 has properties similar to those of natural hard cheese, and thus can be used in all dishes that utilize hard cheese. In addition, it can maintain a natural flavor and taste, and since it does not go through a process such as conventional spray drying, the loss of flavor is low, and thus consumer preference can be improved.

Hereinafter, with reference to the attached drawings, a method for producing a vegetable hard cheese with improved properties and flavor according to an embodiment of the technical idea of the present disclosure will be described in more detail by way of an example.

### Example 1

First, ingredients consisting of 15 parts by weight of purified water, 45 parts by weight of vegetable oil, 10 parts by weight of starch, 10 parts by weight of modified starch, 4 parts by weight of salt, and 2 parts by weight of flavoring were prepared and placed in a container.

At this time, walnut oil and cashew oil were mixed in a weight ratio of 1:1 as the vegetable oil, corn starch and tapioca starch were mixed in a weight ratio of 1:1 as the starch, and oxidized starch was used as the modified starch.

Next, the ingredients added to the container were mixed and stirred for 3 minutes at a speed of 550 rpm to prepare a homogenized emulsion, and the emulsion was sterilized by heating at 90° C. for 60 seconds.

Next, the sterilized emulsion was packaged in a slice shape.

Next, the emulsion packaged in a slice shape was cooled at a temperature of 2° C. for 7 days to solidify, thereby producing a vegetable cheese having a moisture content of 40%.

Next, the solidified vegetable cheese was fine shredded to produce a vegetable hard cheese.

### Example 2

First, ingredients consisting of 18 parts by weight of purified water, 42 parts by weight of vegetable oil, 13 parts by weight of starch, 7 parts by weight of modified starch, 5 parts by weight of salt, and 2 parts by weight of flavoring were prepared and placed in a container.

At this time, avocado oil and almond oil were mixed in a weight ratio of 1:1 as the vegetable oil, potato starch and tapioca starch were mixed in a weight ratio of 1:1 as the starch, and sodium octenyl succinate was used as the modified starch.

Next, the ingredients added to the container were mixed and stirred for 2 minutes at a speed of 580 rpm to prepare a homogenized emulsion, and the emulsion was sterilized by heating at 87° C. for 80 seconds.

Next, the sterilized emulsion was packaged in a slice shape.

Next, the emulsion packaged in a slice shape was cooled at a temperature of 2° C. for 7 days to solidify, thereby producing a vegetable cheese having a moisture content of 42%.

Next, the solidified vegetable cheese was fine shredded to produce a vegetable hard cheese.

### Example 3

First, ingredients consisting of 13 parts by weight of purified water, 48 parts by weight of vegetable oil, 7 parts by weight of starch, 13 parts by weight of modified starch, 3 parts by weight of salt, and 2 parts by weight of flavoring were prepared and placed in a container.

At this time, olive oil and cocoa butter were mixed in a weight ratio of 1:1 as the vegetable oil, potato starch and corn starch were mixed in a weight ratio of 1:1 as the starch, and hydroxypropyl distarch phosphate was used as the modified starch.

Next, the ingredients added to the container were mixed and stirred for 4 minutes at a speed of 520 rpm to prepare a homogenized emulsion, and the emulsion was sterilized by heating at 92° C. for 40 seconds.

Next, the sterilized emulsion was packaged in a slice shape.

Next, the emulsion packaged in a slice shape was cooled at a temperature of 2° C. for 8 days to solidify, thereby producing a vegetable cheese having a moisture content of 38%.

Next, the solidified vegetable cheese was fine shredded to produce a vegetable hard cheese.

### Example 4

First, ingredients consisting of 15 parts by weight of purified water, 45 parts by weight of vegetable oil, 10 parts by weight of starch, 10 parts by weight of modified starch, 4 parts by weight of salt, 3 parts by weight of thickener, and 2 parts by weight of flavoring were prepared and placed in a container.

At this time, walnut oil and cashew oil were mixed in a weight ratio of 1:1 as the vegetable oil, corn starch and tapioca starch were mixed in a weight ratio of 1:1 as the starch, oxidized starch was used as the modified starch, and a sodium alginate extract mixture and xanthan gum were mixed in a weight ratio of 1:1 as the thickener.

Next, the ingredients added to the container were mixed and stirred for 3 minutes at a speed of 550 rpm to prepare a homogenized emulsion, and the emulsion was sterilized by heating at 90° C. for 60 seconds.

Next, the sterilized emulsion was packaged in a slice shape.

Next, the emulsion packaged in a slice shape was cooled at a temperature of 2° C. for 7 days to solidify, thereby producing a vegetable cheese having a moisture content of 41%.

Next, the solidified vegetable cheese was fine shredded to produce a vegetable hard cheese.

### Comparative Example

Parmigiano-Reggiano cheese from Company A, which is sold commercially, was prepared and used as a hard cheese according to the comparative example.

### Experimental Method

### 1. Analysis of General Components and Nutritional Components of Cheese

The general components of the cheese according to Examples 1, 2, 3, and 4 and the comparative example were analyzed by requesting an authorized food component analysis agency.

### 2. Appearance Observation

Appearance observations were made using a digital camera (DMC-FX10, Panasonic, Osaka, Japan) to photograph the appearance of the cheese without the flash going off, keeping the distance between the sample and the camera constant.

### 3. Ph Measurement

The pH of the cheese was measured by direct pricking without dilution using a pH meter (HI-99161 Hanna, Germany).

### 4. Moisture Content

The moisture content was measured at room temperature using a multi-functional moisture meter.

### 5. Hardness Measurement

The cheese was cut into a cylindrical shape with a diameter of 35 cm, and the hardness of the sample was measured at room temperature by penetrometry using a cylindrical probe with a diameter of 2 mm, a speed of 1 mm/sec, and a force threshold of 0.05 N, with a penetration depth of 10 mm. The measurements were repeated five times and the average value was calculated.

### 6. Sensory Evaluation

Sensory evaluation was conducted mainly by experts in hard cheese, and the subjects were 10 researchers and 20 general consumers. Color, cheese flavor, softness, springiness, chewiness, and overall acceptability were evaluated using a 5-point scale. It was evaluated as 5 points for very like (strong), 3 points for neither like nor dislike, and 1 point for very dislike (weak).

The sample was provided in a white plastic dish with 15 g per person, and the selected panel recorded their age, gender, etc., and each sample was provided with a water cup, a sample spitting cup, and water from a water purifier between the samples.

### Experimental Results

### Ingredient Analysis

TABLE 1
Key nutrient content per 100 grams/by an accredited food analysis
laboratory/comparative example is based on product labeling

| | | | | | Comparative |
|---|---|---|---|---|---|
| Food Ingredient/Unit | Example 1 | Example 2 | Example 3 | Example 4 | Example |
| Energy/Kcal | 196 | 192 | 201 | 205 | 338 |
| Moisture(%) | 25 | 27 | 28 | 26 | 23 |
| Protein/g | 5 | 4 | 4 | 6 | 20 |
| Lipid/g | 1 | 1 | 1 | 2 | 21 |
| Ash/g | 1 | 1 | 1 | 1 | — |
| Carbohydrates/g | 44 | 46 | 45 | 48 | 8 |
| Total sugar/g | 6 | 5 | 6 | 7 | — |
| Total dietary fiber/g | 5 | 7 | 7 | 9 | — |
| Total essential fatty acids/g | 4 | 5 | 4 | 6 | — |
| Total saturated fatty acids/g | 1 | 0.9 | 1.1 | 1.2 | 15 |
| Calcium/mg | 24 | 23 | 20 | 25 | 640 |
| Iron/mg | 1.1 | 0.8 | 0.9 | 1.2 | — |
| Magnesium/mg | 32 | 30 | 31 | 34 | 15 |
| Phosphorus/mg | 62 | 58 | 59 | 62 | — |
| Potassium/mg | 84 | 82 | 83 | 86 | — |
| Sodium/mg | 72 | 75 | 74 | 98 | 380 |
| Cholesterol/mg | 0 | 0 | 0 | 0 | 35 |

Referring to the above [Table 1], it can be seen that the vegetable hard cheese according to Examples 1, 2, 3, and 4 has excellent nutritional properties.

### 2. Appearance, pH, Moisture and Hardness

TABLE 2

| Classification | Appearance | pH | moisture | hardness (N/m²) |
|---|---|---|---|---|
| Example 1 | off-white | 5.3 | 25 | 36000 |
| Example 2 | off-white | 5.2 | 27 | 35000 |
| Example 3 | off-white | 5.2 | 28 | 35000 |
| Example 4 | off-white | 5.5 | 26 | 36000 |
| Comparative | light off- | 5.4 | 23 | 33000 |
| Example | white | | | |

Referring to Table 2 above, it can be seen that the vegetable hard cheeses according to Examples 1, 2, 3, and 4 have excellent texture and organization.

### 3. Sensory Evaluation

TABLE 3

| Classification | color | flavor | softness | springiness | chewiness | acceptability |
|---|---|---|---|---|---|---|
| Example 1 | 4.5 | 4.6 | 4.5 | 4.4 | 4.5 | 4.5 |
| Example 2 | 4.6 | 4.5 | 4.5 | 4.3 | 4.5 | 4.4 |
| Example 3 | 4.7 | 4.5 | 4.4 | 4.3 | 4.6 | 4.4 |
| Example 4 | 4.6 | 4.7 | 4.6 | 4.5 | 4.4 | 4.6 |
| Comparative | 4.2 | 3.5 | 3.3 | 3.4 | 3.7 | 3.2 |
| Example | | | | | | |

Referring to Table 3 above, it can be seen that the vegetable hard cheeses according to Examples 1, 2, 3, and 4 have excellent sensory properties, including color, flavor, softness, springiness, chewiness, and acceptability.

Although a preferred embodiment of the present disclosure has been described above with reference to the attached drawings, those skilled in the art to which the present disclosure pertains will understand that the present disclosure can be embodied in other specific forms without changing its technical spirit or essential features. Therefore, one embodiment described above should be understood as illustrative in all respects and not limiting.

What is claimed is:

1. A method for producing a vegetable hard cheese with improved properties and flavor, the method comprising:
an ingredient input step of preparing and placing ingredients in a container;
an emulsifying step of mixing and stirring the ingredients in the container to produce an emulsion;
a sterilization step of heating the emulsion for sterilization;
a shaped packaging step of packaging the sterilized emulsion in a slice form or block form;
a cooling step of cooling and solidifying the emulsion packaged in the slice form or block form to produce a solidified vegetable cheese; and
a grinding processing step of grinding the solidified vegetable cheese to produce a vegetable hard cheese.

2. The method of claim 1, wherein, in the ingredient input step, the ingredients comprise purified water, vegetable oil, starch, modified starch, salt and flavoring,
wherein the vegetable oil includes at least one selected from the group consisting of coconut oil, sunflower oil, rapeseed oil, canola oil, cottonseed oil, peanut oil, olive oil, moringa oil, algae oil, safflower oil, corn oil, rice bran oil, sesame oil, hazelnut oil, avocado oil, almond oil, walnut oil, cashew nut oil, shea butter, palm oil, and cocoa butter,
wherein the starch includes at least one selected from the group consisting of potato starch, corn starch, and tapioca starch, and
wherein the modified starch includes at least one selected from the group consisting of oxidized starch, starch sodium octenyl succinate, and hydroxypropyl distarch phosphate.

3. The method of claim 2, wherein, in the ingredient input step, the ingredients includes 10 to 20 parts by weight of purified water, 40 to 50 parts by weight of vegetable oil, 5 to 15 parts by weight of starch, 5 to 15 parts by weight of modified starch, 2 to 6 parts by weight of salt, and 1 to 3 parts by weight of flavoring.

4. The method of claim 3, wherein the emulsifying step comprises mixing the ingredients in the container and stirring the mixed ingredients at a speed of 500 to 600 rpm for 1 to 5 minutes to produce a homogenized emulsion.

5. The method of claim 4, wherein the sterilization step comprises sterilizing the emulsion at a temperature of 86 to 94° C. for 30 to 90 seconds.

6. The method of claim 5, wherein the cooling step comprises cooling the emulsion packaged in slice form or block form at a temperature of 0 to 4° C. for 6 to 8 days for solidification.

7. A vegetable hard cheese with improved properties and flavor, produced by the method of claim 1.
